(19) United States
(12) Patent Application Publication
(10) Pub. No.: US 2011/0029716 A1
(43) Pub. Date: Feb. 3, 2011

(54) SYSTEM AND METHOD OF RECOVERING DATA IN A FLASH STORAGE SYSTEM

(75) Inventor: Mark Moshayedi, Newport Coast, CA (US)

Correspondence Address: MCDERMOTT WILL & EMERY LLP, 18191 VON KARMAN AVE., SUITE 500, IRVINE, CA, 92612-7108, US

(73) Assignee: STEC, INC., Santa Ana, CA (US)

(21) Appl. No.: 12/511,989

(22) Filed: Jul. 29, 2009

(51) Int. Cl. G06F 12/00; G06F 12/02; G06F 11/16; G06F 12/16

(52) U.S. Cl. 711/103; 714/6; 711/162; 714/E11.055; 711/E12.001; 711/E12.008; 711/E12.103

(57) ABSTRACT

A flash storage system includes a system controller that generates redundant data based on data stored in flash storage devices of the flash storage system. The system controller stores the redundant data in one or more of the flash storage devices. Additionally, the system controller identifies data that has become unavailable in one or more of the flash storage device, recovers the unavailable data based on the redundant data, and stores the recovered data into one or more other flash storage devices of the flash storage system.

### BACKGROUND

1. Field of Invention

The present invention generally relates to flash storage systems, and more particularly to recovering data in a flash storage system.

2. Description of Related Art

Flash storage systems have become the preferred technology for many applications in recent years. The ability to store large amounts of data and to withstand harsh operating environments, together with the non-volatile nature of the storage, makes these flash storage devices appealing for many applications.

A typical flash storage system includes a number of flash storage devices and a controller. The controller writes data into storage blocks of the flash storage device and reads data from these storage blocks. Additionally, the controller performs error detection and correction of corrupt data stored in the storage blocks. For example, the controller may use an error correction code to recover data originally stored in a storage block. The data stored in a storage block is sometimes corrupt because of a physical failure of the storage block containing the data. In many flash storage systems, the controller identifies corrupt data stored in a failed storage block, recovers the data originally written into the failed storage block, and writes the recovered data into a spare storage block in the flash storage device. Although this technique has been successfully used to recover corrupt data in a fail storage block, the number of spare storage blocks in a flash storage device may become exhausted. Thus, this technique is limited by the number of spare storage blocks in the flash storage device. Moreover, the flash storage device may itself experience a physical failure which prevents the controller from recovering data in the failed flash storage device.

In light of the above, a need exists for an improved system and method of recovering data in a flash storage system. A further need exists for recovering data in a failed flash storage device of a flash storage system.

### SUMMARY

In various embodiments, a flash storage system includes a system controller that generates redundant data based on data stored in flash storage devices of the flash storage system. The system controller stores the redundant data in one or more of the flash storage devices. Additionally, the system controller identifies data that has become unavailable in one or more of the flash storage devices, recovers the unavailable data based on the redundant data, and stores the recovered data into one or more other flash storage devices of the flash storage system.

A data storage system, in accordance with one embodiment, includes flash storage devices and a system controller coupled to the flash storage devices. The system controller is configured to store data units in the flash storage devices and to generate redundant data units based on the data units. Further, the system controller is configured to store the redundant data units in at least one of the flash storage devices for recovering at least one of the data units based on at least one of the redundant data units.

A method for storing data, in accordance with one embodiment, includes storing data units in flash storage devices and generating redundant data units based on the data units. The method further includes storing the redundant data units in at least one of the flash storage devices for recovering at least one of the data units based on at least one of the redundant data units.

A data storage system, in accordance with one embodiment, includes flash storage devices and a means for storing data units in the flash storage devices. The data storage system further includes a means for generating redundant data units based on the data units. The data storage system also includes a means for storing the redundant data units in at least one of the flash storage devices for recovering at least one of the data units based on the redundant data units.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a block diagram of an electronic system including a flash storage system, in accordance with an embodiment of the present invention;

FIG. 2 is a block diagram of a flash storage device, in accordance with an embodiment of the present invention;

FIG. 3 is a block diagram of a storage map for a flash storage device, in accordance with an embodiment of the present invention;

FIG. 4 is a block diagram of storage maps for flash storage devices, in accordance with an embodiment of the present invention;

FIG. 5 is a block diagram of storage maps for flash storage devices, in accordance with an embodiment of the present invention;

FIG. 6 is a block diagram of storage maps for flash storage devices, in accordance with an embodiment of the present invention;

FIG. 7 is a block diagram of storage maps for flash storage devices, in accordance with an embodiment of the present invention; and

FIG. 8 is a flow chart for a method of recovering data in a flash storage system, in accordance with an embodiment of the present invention.

### DESCRIPTION

In various embodiments, a flash storage system generates redundant data based on data stored in flash storage devices of the flash storage system. The system controller stores the redundant data in one or more of the flash storage devices. Additionally, the flash storage system identifies data that has become unavailable in one or more of the flash storage devices, recovers the unavailable data based on the redundant data, and stores the recovered data into one or more other flash storage devices of the flash storage system.

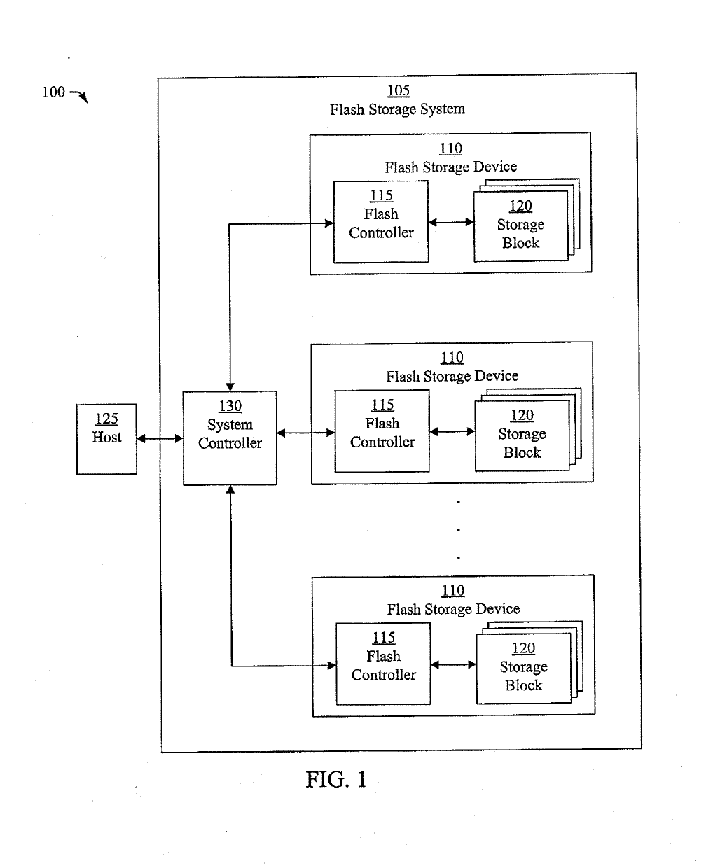

FIG. 1 illustrates an electronic system 100, in accordance with an embodiment of the present invention. The electronic system 100 includes a flash storage system 105 and a host 125 coupled to the flash storage system 105. The host 125 writes data into the flash storage system 105 and reads data from the flash storage system 105. The host 125 may be any computing or electronic device, such as a computer workstation, an embedded computing system, a network router, a portable computer, a personal digital assistant, a digital camera, a digital phone, or the like. The flash storage system 105 includes flash storage devices 110 and a system controller 130 coupled to the flash storage devices 110. Each of the flash storage devices 110 may be any type of flash storage, such as a solid-state drive, a flash memory card, a secure digital (SD) card, a universal serial bus (USB) memory device, a flash storage array, a CompactFlash card, SmartMedia, a flash storage array, or the like. The system controller 130 may include a microprocessor, a microcontroller, an embedded controller, a logic circuit, software, firmware, or any kind of processing device. Although four flash storage devices 110 are illustrated in FIG. 1, the flash storage system 105 may have more or fewer flash storage devices 110 in other embodiments.

The system controller 130 writes data into the flash storage devices 110 and reads data from the flash storage devices 110. Additionally, the system controller 130 generates redundant data based on the data stored in the flash storage devices 110 for recovering data that becomes unavailable in one or more of the flash storage devices 110, as is described more fully herein. For example, data may become unavailable in one of the flash storage devices 110 if the data stored in that flash storage device 110 is unavailable, the flash storage device 110 has failed, or the flash storage device 110 is disconnected from the flash storage system 105.

Each of the flash storage devices 110 includes storage blocks 120 and a flash controller 115 coupled to the storage blocks 120. The flash controller 115 may include a microprocessor, a microcontroller, an embedded controller, a logic circuit, software, firmware, or any kind of processing device. The flash controller 115 stores data into the storage blocks 120 and reads data from the storage blocks 120. In one embodiment, the flash controller 115 identifies corrupt data stored in a storage block 120, recovers the data based on the corrupted data, and writes the recovered data into another storage block 120 of the flash storage device 110, as is described more fully herein. For example, the flash storage device 110 may recover the data that has become corrupt by using an error correction code (ECC), such as parity bits stored in the flash storage device 110. Each of the storage blocks 120 has a data size, which determines the capacity of the storage block 120 to store data. For example, a storage block 120 may have a data size of 512 data bytes.

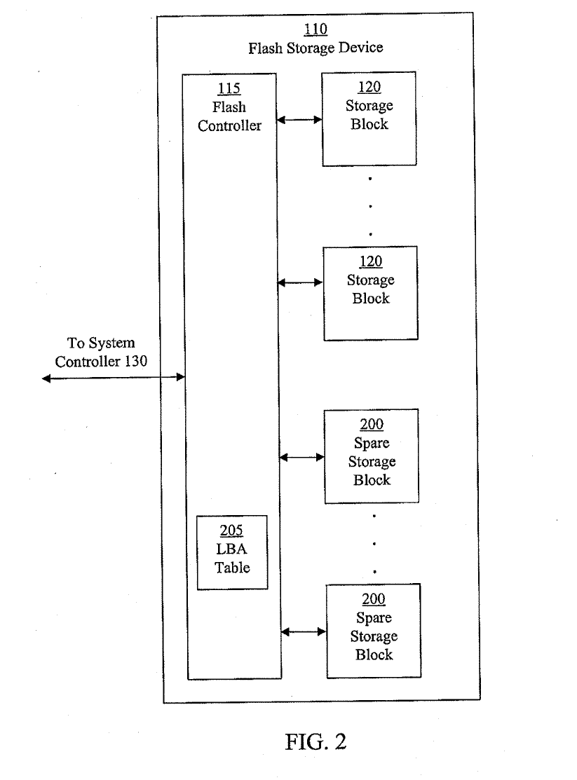

FIG. 2 illustrates the flash storage device 110, in accordance with an embodiment of the present invention. In addition to the flash controller 115 and the storage blocks 120, the flash storage device 110 includes spare storage blocks 200 coupled to the flash storage controller 115. The flash controller 115 includes a logical block address table (LBA table) 205, which defines a storage map of the flash storage device 110. The LBA table 205 maps physical addresses of the flash storage device 110 to logical addresses of the storage blocks 120 and the spare storage blocks 200. In various embodiments, the flash controller 115 initially maps the physical addresses of the flash storage device 110 to logical block addresses of the storage blocks 120. The flash controller 115 then writes data into the storage blocks 120, and reads data from the storage blocks 120, using the LBA table 205.

In some cases, original data stored in the storage blocks 120 of the flash storage device 110 may become corrupt. For example, a storage block 120 may have a physical failure which causes the original data stored into a failed storage block 120 to become corrupt. The flash controller 115 corrects the corrupt data by using an error correction code (ECC), such as parity bits. The flash controller 115 generates the ECC for data to be stored in the storage blocks 120 and writes the ECC into the storage blocks 120 along with the data. On a subsequent read of the data, the flash controller 115 detects corrupt data based on the ECC, corrects the corrupt data based on the ECC to recover the original data, and writes the corrected data into one of the spare storage blocks 200. Further, the flash controller 115 modifies the LBA table 205 so that the physical addresses of the flash storage device 110 mapped to logical addresses of the failed storage block 120 are mapped to logical addresses of the spare storage block 200. Although two storage blocks 120 and two spare storage blocks 200 are illustrated in FIG. 2, the flash storage device 110 may have more or fewer than two storage blocks 120 in other embodiments. Further, the flash storage device 110 may have more or fewer than two spare storage blocks 200 in other embodiments.

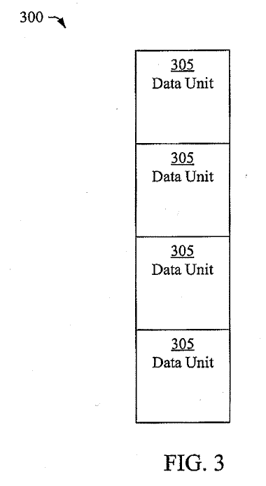

FIG. 3 illustrates a storage map 300 of a flash storage device 110, in accordance with one embodiment of the present invention. As indicated in the storage map 300, the flash storage device 110 contains four data units 305 stored in the flash storage device 110. The data units 305 stored in the storage blocks 120 of the flash storage device 110 may be any unit of data, which determines a data size of the data unit. For example, a data unit 305 may be a data bit, a data byte, a data word, a data block, a data record, a data file, a data sector, a memory page, a logic sector, or a file sector, or any other unit of data. In some embodiments, the data units 305 have the same data size s the data size of a storage block 120. In other embodiments, the data units 305 may have a data size that is larger or smaller than the data size of a storage block 120. Thus, in some embodiments, a storage block 120 may store more than one data unit 305 or may store one or more portions of a data unit 305. Although four data units 305 are illustrated in FIG. 3, the flash storage device 110 may store more or fewer data units 305 in other embodiments.

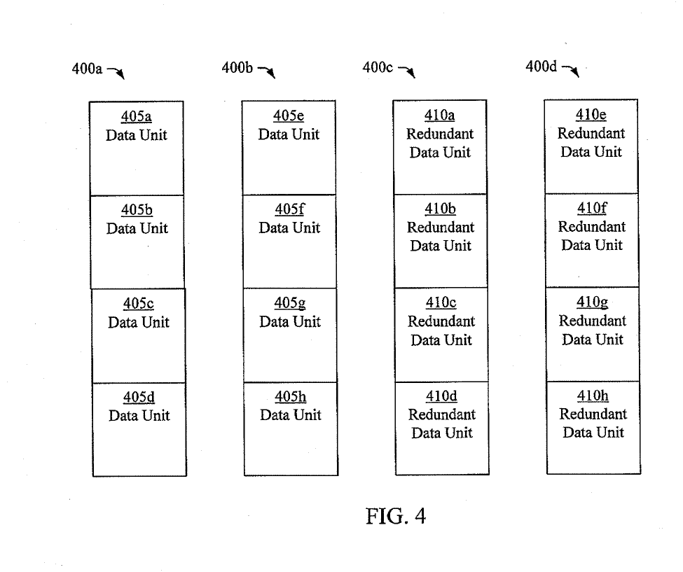

FIG. 4 illustrates storage maps 400 (e.g., storage maps 400a-d) for the flash storage devices 110 of the flash storage system 105, in accordance with an embodiment of the present invention. The storage maps 400 correspond to the flash storage devices 110 in the flash storage system 105. As indicated in the storage maps 400, some of the flash storage devices 110 contain data units 405 (e.g., data units 405a-h) and other flash storage devices 110 contain redundant data units 410 (e.g., redundant data units 410a-h). The system controller 130 generates the redundant data units 410 based on the data units 405 by mirroring the data units 405. In this process, the system controller 130 generates the redundant data units 410 by copying the data units 405 stored in some of the flash storage devices 110 and writing the redundant data units 410 into other flash storage devices 110 of the flash storage system 105. Thus, the redundant data units 410 are copies corresponding to the data units 405 stored in the flash storage devices 110 of the flash storage system 105. As illustrated, the redundant data units 410a-h correspond to the data units 405a-h.

The system controller 130 monitors the flash storage devices 110 to determine whether any of the data units 405 becomes unavailable. A data unit 405 may become unavailable, for example, if the flash storage device 110 fails or is disconnected from the flash storage system 105. As another example, the data unit 405 may become unavailable if the data unit 405 is corrupt and the flash storage device 110 containing the data unit 405 is unable to correct the data unit 405 using the ECC associated with that data unit 405. If a data unit 405 is unavailable, the system controller 130 provides a signal to the host 125 indicating that the flash storage device 110 containing the data unit 405 has failed. The system controller 130 then reads the data unit 410 corresponding to the unavailable data unit 405 from the flash storage device 110 containing the redundant data unit 410. Further, the system controller 130 reads and writes the redundant data units 410 corresponding to the data units 405 in the failed flash storage device 110 until the failed flash storage device 110 is replaced in the flash storage system 105. In this way, the flash storage system 105 continues to operate substantially uninterrupted by the failure of the flash storage device 110.

When the failed flash storage device 110 is replaced in the flash storage system 105, the system controller 130 detects the replacement flash storage device 110. In one embodiment, the replacement flash storage device 110 provides a signal to the system controller 130 indicating that the replacement flash storage device 110 has been connected to the flash storage system 105. For example, the replacement flash storage device 110 may include a physical latch or a mechanical relay that is activated to generate the signal when the replacement flash storage device 110 is connected to the flash storage system 105. After the system controller 130 detects the replacement flash storage device 110, the system controller 130 copies the redundant data units 410 corresponding to the data units 405 in the failed flash storage device 110 into the replacement flash storage device 110. In one embodiment, the system controller 130 subsequently reads and writes the data units 405 in the replacement flash storage device 110 instead of the redundant data units 410 corresponding to the data units 405. In another embodiment, these redundant data units 410 are deemed data units 405 and the data units 405 in the replacement flash storage device 110 are deemed redundant data units 410.

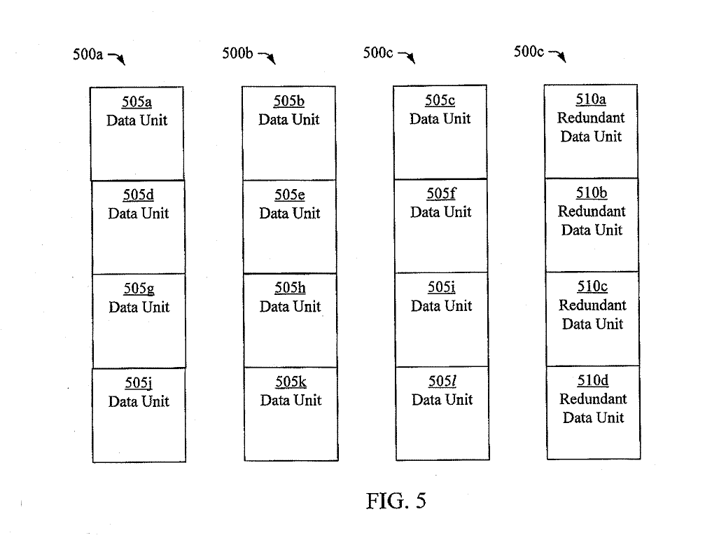

FIG. 5 illustrates storage maps 500 (e.g., storage maps 500a-d) for the flash storage devices 110 of the flash storage system 105, in accordance with another embodiment of the present invention. The storage maps 500 correspond to the flash storage devices 110 in the flash storage system 105. As indicated in the storage maps 500, the flash storage devices 110 contain data units 505 (e.g., data units 505a-l) and redundant data units 510 (e.g., redundant data units 510a-d). The system controller 130 generates the redundant data units 410 based on the data units 405. As illustrated, the system controller 130 generates the redundant data unit 510a based on the data units 505a-c, the redundant data unit 510b based on the data units 505d-f, the redundant data unit 510c based on the data units 505g-i, and the redundant data unit 510d based on the data units 505j-l.

The redundant data units 510 are stored in one of the flash storage devices 110 dedicated to storing redundant data units 510 and the data units 505 are stored in the other flash storage devices 110. Each of the data units 505 stored in a flash storage device 110 corresponds to one of the redundant data units 510. The system controller 130 generates each redundant data unit 510 based on the data units 505 corresponding to that redundant data unit 510 and stores the redundant data unit 510 in the flash storage device 110 dedicated to redundant data units 510. For example, the system controller 130 may perform an exclusive OR (XOR) operation on the data units 505 to generate the redundant data unit 510 corresponding to those data units 505.

If a flash storage device 110 other than the flash storage device 110 dedicated to redundant data units 510 experiences a failure, the system controller 130 recovers each of data units 505 in the failed flash storage device 110 based on the corresponding data units 505 and the corresponding redundant data unit 510. If the flash storage device 110 dedicated to redundant data units 510 experiences a failure, the system controller 130 recovers each redundant data unit 510 in the failed flash storage device 110 based on the data units 505 corresponding to the redundant data unit 510. In this way, the flash storage system 105 continues to operate substantially uninterrupted by the failure of the flash storage device 110. After the failed flash storage device 110 is replaced in the flash storage system 105 with a replacement flash storage device 110, the system controller 130 recovers the data units 410 or the redundant data units 410 in the failed flash storage device 110 and writes the recovered data units 410 or the recovered redundant data units 410 into the replacement flash storage device 110.

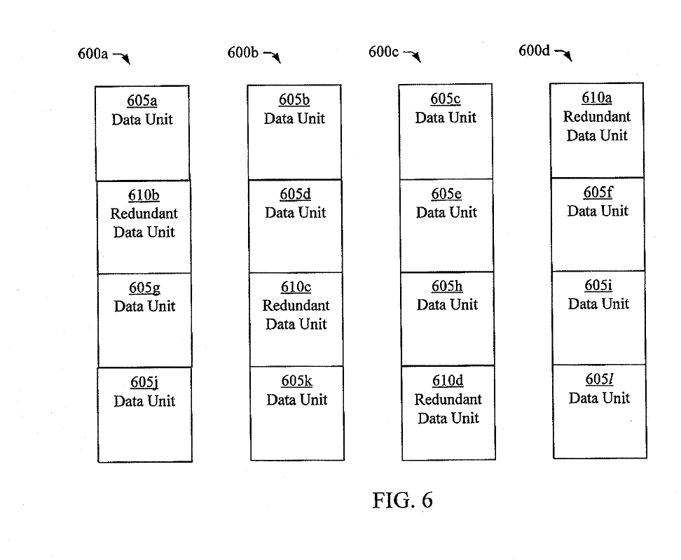

FIG. 6 illustrates storage maps 600 (e.g., storage maps 600a-d) for the flash storage devices 110 of the flash storage system 105, in accordance with another embodiment of the present invention. The storage maps 600 correspond to the flash storage devices 110 in the flash storage system 105. As indicated in the storage maps 600, the flash storage devices 110 contain data units 605 (e.g., data units 605a-l) and redundant data units 610 (e.g., redundant data units 610a-d). The system controller 130 generates each redundant data unit 610 based on data units 605 corresponding to the redundant data unit 610. Moreover, the data units 605 and the redundant data units 610 are distributed among the flash storage devices 110. As illustrated, the system controller 130 generates the redundant data unit 610a based on the data units 605a-c, the redundant data unit 610b based on the data units 605d-f, the redundant data unit 610c based on the data units 605g-i, and the redundant data unit 610d based on the data units 605j-l. Further, the redundant data units 610a-d are stored in corresponding flash storage device 110 such that each of the flash storage devices 110 contains one of the redundant data units 610a-d.

The system controller 130 generates each of the redundant data units 610 based on the data units 605 corresponding to the redundant data unit 610 and stores the redundant data unit 610 is a flash storage device 110 that does not contain any of those data units 605. For example, the system controller 130 may perform an exclusive OR operation on the data units 605 to generate the redundant data unit 610.

As illustrated, the redundant data units 610 are striped across the flash storage devices 110. In the case of a failed flash storage device 110, the system controller 130 recovers an unavailable data unit 605 in the failed flash storage device 110 based on the data units 605 and the redundant data unit 610 corresponding to the unavailable data unit 605. Similarly, the system controller 130 recovers an unavailable redundant data unit 610 in the failed flash storage device 110 based on the data units 605 data corresponding to the unavailable redundant data unit 610. In this way, the flash storage system 105 continues to operate substantially uninterrupted by the failure of the flash storage device 110. After the failed flash storage device 110 is replaced in the flash storage system 105 with a replacement flash storage device 110, the system controller 130 recovers the data units 605 and the redundant data unit 610 stored in the failed flash storage device 110 and stores the recovered data units 605 and the redundant data unit 610 into the replacement flash storage device 110.

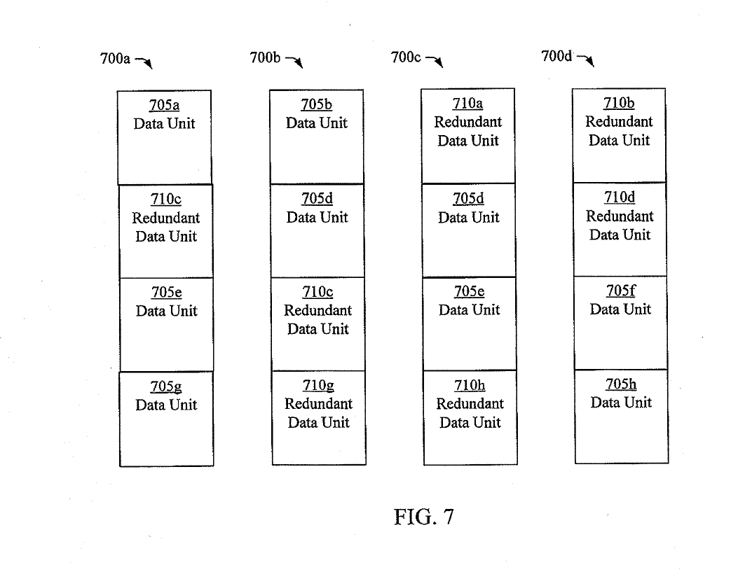

FIG. 7 illustrates storage maps 700 (e.g., storage maps 700a-d) for the flash storage devices 110 of the flash storage system 105, in accordance with another embodiment of the present invention. The storage maps 700 correspond to the flash storage devices 110 in the flash storage system 105. As indicated in the storage maps 700, the flash storage devices 110 contain data units 705 (e.g., data units 705a-h) and redundant data units 710 (e.g., redundant data units 710a-h). The system controller 130 generates the redundant data units 710 based on the data units 705. The data units 705 and the redundant data units 710 are distributed among the flash storage devices 110. As illustrated, the system controller 130 generates the redundant data units 710a and 710b based on the data units 705a and 705b, the redundant data units 710c and 710d based on the data units 705c and 705d, the redundant data units 710e and 710f based on the data units 705e and 705f, and the redundant data units 710h and 710h based on the data units 705g and 705h. Further, the redundant data units 710 corresponding to data units 705 are stored in corresponding flash storage device 110 such that each of these flash storage devices 110 contains one of the redundant data units 710.

The system controller 130 generates each of the redundant data units 710 based on the data units 705 corresponding to the redundant data unit 710. In this embodiment, the system controller 130 generates more than one redundant data unit 710 based on the data units corresponding to each of these redundant data units 710. For example, the system controller 130 may perform an exclusive OR operation on the data units 705 corresponding a redundant data unit 710 to generate that redundant data unit 710. Additionally, the system controller 130 may perform another operation on the data units 705 corresponding to another redundant data unit 710 to generate that redundant data unit 710.

As illustrated, the redundant data units 710 are striped across the flash storage devices 110. In the case of a failed flash storage device 110, the system controller 130 recovers an unavailable data unit 705 stored in the failed flash storage device 110 based on one or more of the data units 705 and the redundant data units 710 corresponding to the unavailable data unit, which are stored in flash storage devices 110 other than the failed flash storage device 110. Similarly, the system controller 130 recovers a redundant data unit 710 stored in the failed flash storage device 110 based on the data units 705 corresponding to the redundant data unit 710, which are stored in flash storage devices 110 other than the failed flash storage device 110. In this way, the flash storage system 105 continues to operate substantially uninterrupted by the failure of the flash storage device 110. After the failed flash storage device 110 is replaced in the flash storage system 105 with a replacement flash storage device 110, the system controller 130 recovers the data units 410 and the redundant data units 410 stored in the failed flash storage device 110 and stores the recovered data units 705 and the redundant data unit 710 into the replacement flash storage device 110.

In some embodiments, the system controller 130 generates the multiple redundant data units 710 based on the data units 705 corresponding to those redundant data units 710 such that the system controller 130 recovers unavailable data units 705 in multiple failed flash storage devices 110. For example, the redundant data units 710 corresponding to data units 705 may be base on a Reed-Solomon Code as is commonly known in the art.

In various embodiments, the flash storage system 105 includes one or more spare flash storage devices 110. In these embodiments, the system controller 130 recovers unavailable data (e.g., data units and redundant data units) in a failed flash storage device 110 and writes the recovered data into one of the spare flash storage devices 110. Thus, the spare storage device 110 becomes a replacement flash storage device 110 for the failed flash storage device 110. Moreover, the system controller 130 recovers the unavailable data and stores the recovered data into the spare flash storage device 110 such that operation of the flash storage system 105 is uninterrupted by the failure of the flash storage device 110. The system controller 130 also provides a signal to the host 125 indicating that the flash storage device 110 has experienced the failure. The failed flash storage device 110 may then be replaced in the flash storage system 105. After the failed flash storage device 110 is replaced in the flash storage system 105, the replaced flash storage device 110 becomes a spare flash storage device 110 in the flash storage system 105. In this way, the system controller 130 recovers the data and maintains the redundant data (e.g., the redundant data units) after a flash storage device 110 experiences a failure in the flash storage system 105.

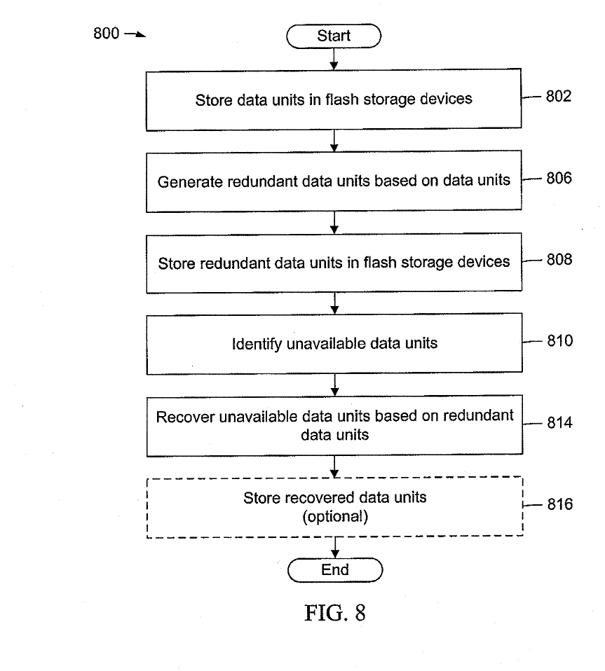

FIG. 8 illustrates a method 800 of recovering data in the flash storage system 105, in accordance with an embodiment of the present invention. In step 802, the system controller 130 of the flash storage system 105 receives data units from the host 125 and writes the data units into the flash storage devices 110. The method 800 then proceeds to step 806.

In step 806, the system controller 130 generates redundant data units based on the data units received from the host 125. In some embodiments, the system controller 130 generates the redundant data units by mirroring the data units received from the host 125. In other embodiments, the system controller 130 generates the redundant data units based on the data units stored in the flash storage devices 110. The method 800 then proceeds to step 808.

In step 808, the system controller 130 writes the redundant data units into the flash storage devices 110. In some embodiments, the system controller 130 writes the redundant data units into one of the flash storage devices 110, which is dedicated to redundant data units. In other embodiments, the system controller 130 distributes the redundant data units among the flash storage devices 110. The method 800 then proceeds to step 810.

In step 810, the system controller 130 identifies one or more unavailable data units. The unavailable data units are data units previously stored in one of the flash storage devices 110. For example, a data unit may become unavailable because of a physical failure of the flash storage device 110 storing that data unit or because the flash storage device 110 storing that data unit has been disconnected from the flash storage system 105. The method 800 then proceeds to step 814.

In step 814, the system controller 130 recovers the unavailable data units based on the redundant data units. In one embodiment, the system controller 130 recovers the unavailable data units by reading the redundant data units that correspond to the unavailable data units from a flash storage device 110 other than the failed flash storage device 110. In another embodiment, the system controller 130 recovers each unavailable data unit based on the redundant data corresponding to that unavailable data unit and based on one or more other data units corresponding to the unavailable data units, which are stored in one or more flash storage devices 110 other than the failed flash storage device 110. The method 800 then proceeds to step 816.

In optional step 816, the system controller 130 stores the recovered data units in a replacement flash storage device 110 in the flash storage system 105. The replacement flash storage device 110 may be a spare flash storage device 110 in the flash storage system 105 or a flash storage device 110 that has been connected to the flash storage system 105 to replace the failed flash storage device 110. The method 800 then ends. In embodiments without step 816, the method 800 ends after step 816.

In various embodiments, the steps of the method 800 may be performed in a different order than that described above with reference to FIG. 8. In some embodiments, the method 800 may include more or fewer steps than those steps illustrated in FIG. 8. In other embodiments, some or all of the steps of the method 800 may be performed in parallel with each other or substantially simultaneously with each other.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A data storage system comprising:
a plurality of flash storage devices; and
a system controller coupled to the plurality of flash storage devices, the system controller configured to store a plurality of data units in the plurality of flash storage devices, the system controller further configured to generate a plurality of redundant data units based on the plurality of data units and to store the plurality of redundant data units in at least one flash storage device the plurality of flash storage devices for recovering at least one data unit of the plurality of data units based on at least one redundant data unit of the plurality of redundant data units.

2. The data storage system of claim 1, wherein the system controller is further configured to generate the plurality of redundant data units by mirroring the plurality of data units.

3. The data storage system of claim 1, wherein the system controller is further configured to generate the plurality of redundant data units based on at least two data units of the plurality of data units, the at least two data units being distributed among at least two flash storage devices of the plurality of flash storage devices.

4. The data storage system of claim 3 further configured to recover one of the at least two data units of the plurality of data units based on at least one other data unit of the at least two data units and at least one redundant data unit of the plurality of redundant data units.

5. The data storage system of claim 4, wherein the plurality of redundant data units is stored in one flash storage device of the plurality of flash storage devices.

6. The data storage system of claim 4, wherein the plurality of redundant data units is distributed among at least two flash storage devices of the plurality of flash storage devices.

7. The data storage system of claim 4, wherein each flash storage device of the plurality of flash storage devices comprises:
a plurality of storage blocks for storing data units;
at least one spare storage block; and
a flash controller coupled to the plurality of storage blocks comprising at least one spare storage block, the flash controller configured to identify a corrupt data unit stored in a storage block of the plurality of storage blocks, the flash controller further configured to recover the corrupt data unit and to store the recovered data unit in the at least one spare storage block of the plurality of storage blocks.

8. The data storage system of claim 1, wherein the redundant data comprises parity data.

9. A method for storing data comprising:
storing a plurality of data units in a plurality of flash storage devices;
generating a plurality of redundant data units based on the plurality of data units; and
storing the plurality of redundant data units in at least one flash storage device of the plurality of flash storage devices for recovering at least one data unit of the plurality of data units based on at least one redundant data unit of the plurality of redundant data units.

10. The method of claim 9, further comprising generating the plurality of redundant data units by mirroring the plurality of data units.

11. The method of claim 9, further comprising generating the plurality of redundant data units based on at least two data units of the plurality of data units, the at least two data units being distributed among at least two flash storage devices of the plurality of flash storage devices.

12. The method claim 11, further comprising:
identifying at least one unavailable data unit of the plurality of data units;
recovering the at least one unavailable data unit based on at least one other data unit of the plurality of data units and at least one redundant data unit of the plurality of redundant data units.

13. The method of claim 12, wherein the plurality of redundant data units is stored in one flash storage device of the plurality of flash storage devices.

14. The method of claim 12, wherein the plurality of redundant data units is distributed among at least two flash storage devices of the plurality of flash storage devices.

15. The method of claim 12, wherein each flash storage device of the plurality of flash storage devices comprises a plurality of storage blocks comprising at least one spare storage block, the method further comprising:
identifying a corrupt data unit stored in a storage block of the plurality of storage blocks;
recovering the corrupt data unit; and
storing the recovered data unit into the at least one spare storage block.

16. The method of claim 9, wherein the redundant data comprises parity data.

17. A data storage system comprising:
a plurality of flash storage devices;
means for storing a plurality of data units in the plurality of flash storage devices;
means for generating a plurality of redundant data units based on the plurality of data units; and
means for storing the plurality of redundant data units in at least one flash storage device of the plurality of flash storage devices for recovering at least one data unit of the plurality of data units based on at least one redundant data unit of the plurality of redundant data units.

18. The data storage system of claim 17, further comprising means for generating the plurality of redundant data units by mirroring the plurality of data units.

19. The data storage system of claim 17, further comprising means for generating the plurality of redundant data units based on at least two data units of the plurality of data units, the at least two data units being distributed among at least two flash storage devices of the plurality of flash storage devices.

20. The data storage system of claim 19, further comprising:
means for identifying at least one unavailable data unit of the plurality of data units; and
means for recovering the at least one unavailable data unit of the plurality of data units based on at least one other data unit of the plurality of data units and at least one redundant data unit of the plurality of redundant data units.
